(19) United States
(12) Patent Application Publication
(10) Pub. No.: US 2017/0192133 A1
(43) Pub. Date: Jul. 6, 2017

(54) OPTICAL ELEMENT AND IMAGING APPARATUS

(71) Applicant: Asahi Glass Company, Limited, Chiyoda-ku (JP)

(72) Inventors: Takaaki MURAKAMI, Chiyoda-ku (JP); Hiroshi SHIMODA, Chiyoda-ku (JP); Aya IKOMA, Chiyoda-ku (JP); Kiyoshi TAMAI, Chiyoda-ku (JP)

(73) Assignee: Asahi Glass Company, Limited, Chiyoda-ku (JP)

(21) Appl. No.: 15/466,120

(22) Filed: Mar. 22, 2017

Related U.S. Application Data
(63) Continuation of application No. PCT/JP2015/076299, filed on Sep. 16, 2015.

(30) Foreign Application Priority Data
Sep. 26, 2014 (JP) 2014-196784

(51) Int. Cl. G02B 1/115; G02B 1/04; G02B 1/18; C03C 17/42

(52) U.S. Cl. CPC G02B 1/115; C03C 17/42; G02B 1/04; G02B 1/18; C03C 2217/734

(57) ABSTRACT

An optical element includes a transparent substrate configured to transmit light; a resin layer provided on one surface of the transparent substrate, and configured to transmit light; and a first antireflection film formed on the resin layer.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2015/076299 filed on Sep. 16, 2015 and designating the U.S., which claims priority of Japanese Patent Application No. 2014-196784 filed on Sep. 26, 2014. The entire contents of the foregoing applications are incorporated herein by reference.

### BACKGROUND OF THE INVENTION

1. Field of the Invention

The present invention relates to an optical element.

2. Description of the Related Art

An optical element such as a lens or the like that is used in an optical apparatus is formed of a transparent material such as glass that transmits light. However, as such a material has a predetermined refractive index, about 8% of the light is reflected at a front surface and a back surface. Thus, due to the reflection at the front surface and the back surface of the optical element, transmittance of the light is lowered. In order to suppress the reflection of the light at the front surface or the back surface of the optical element, generally, an antireflection film is provided at the front surface and the back surface of the optical element such as the lens.

Here, in a mobile terminal represented by a smartphone, an imaging apparatus for imaging is installed in addition to a display screen for displaying an image or the like. In the imaging apparatus installed in such a mobile terminal, in order to protect a solid-state imaging element for taking an image, prior to the solid-state imaging element, an optical element formed of a transparent material such as glass that transmits light is provided. Such an optical element is referred to as a cover glass or the like, and disclosed in Japanese Unexamined Patent Application Publication No. 2004-297398, Japanese Unexamined Patent Application Publication No. 2006-171569, or the like.

### SUMMARY OF THE INVENTION

It is a general object of at least one embodiment of the present invention to provide an optical element and an imaging apparatus that substantially obviate one or more problems caused by the limitations and disadvantages of the related art.

According to an aspect of the preferred embodiment, an optical element includes a transparent substrate that transmits light; a resin layer provided on one surface of the transparent substrate, and transmitting light; and a first antireflection film formed on the resin layer.

### BRIEF DESCRIPTION OF THE DRAWINGS

Other objects and further features of embodiments will become apparent from the following detailed description when read in conjunction with the accompanying drawings, in which:

FIG. 1 is a diagram depicting a first example of a structure of an optical element according to a first embodiment;

FIG. 2 is a diagram depicting a second example of the structure of the optical element according to the first embodiment;

FIG. 3 is a diagram depicting a third example of the structure of the optical element according to the first embodiment;

FIG. 4 is a diagram depicting an example of a reflectance characteristic of the optical element according to the first embodiment;

FIG. 5 is a diagram depicting a structure of an optical element according to a first example;

FIG. 6 is a diagram depicting a structure of optical elements according to second to eighth examples;

FIG. 7 is a diagram depicting a structure of optical elements according to second and third comparative examples;

FIGS. 8A and 8B are explanatory diagrams for a smartphone in which an imaging apparatus according to a second embodiment is installed;

FIG. 9 is an explanatory diagram for the imaging apparatus according to the second embodiment; and

FIG. 10 is an explanatory diagram for an optical system of the imaging apparatus according to the second embodiment.

### DESCRIPTION OF THE PREFERRED EMBODIMENTS

### First Embodiment

First, an optical element, in which an antireflection film is deposited on a transparent substrate such as a glass substrate, will be described. For the transparent substrate, an inorganic transparent substrate, which has a greater strength than an organic transparent substrate, is preferred. Furthermore, among the inorganic transparent substrates, a glass substrate or a sapphire substrate is preferably used. When the transparent substrate is a glass substrate that is not provided with an antireflection film, light that enters the glass substrate is reflected at a front surface and at a back surface of the substrate, respectively. In this way, reflectance for light reflected at the front surface and at the back surface of the glass substrate, respectively, is about 4%, and reflectance for the entire optical element is about 8%.

The antireflection film is formed of a dielectric multi-layered film, in which a high refractive index material and a low refractive index material, such as TiO₂ and SiO₂, are alternately stacked, in order to decrease the reflection at the front surface and the back surface of the glass substrate. By providing such an antireflection film on the front surface or the back surface of the glass substrate, the reflectance at one of the front surface and the back surface can be made 2% or less. Therefore, by providing the antireflection films on both surfaces of the glass substrate, the reflectance of the entire optical element can be made 4% or less. Then, the transmittance of the optical element improves by about 4% or more.

Incidentally, in an imaging apparatus installed in a mobile terminal, such as a smartphone, an optical element is provided, for example, for protecting a solid-state imaging element. Then, an image taken by the solid-state imaging element is imported by light entering the solid-state imaging element via the optical element. Therefore, in order to enhance utilization efficiency for the light entering the solid-state imaging element, antireflection films are preferably deposited on both surfaces of a glass substrate or the like that can be used as a transparent substrate so as to increase the transmittance of the optical element.

However, as described later, when the antireflection films are provided on the glass substrate as a transparent substrate, the strength of the substrate has been found to decrease compared with a glass substrate that is not provided with an antireflection film. For example, it is confirmed that when a load is applied to the optical element in which antireflection films are provided on the glass substrate as a transparent substrate from one surface, a fracture occurs from the other surface (a surface opposing the surface to which the load is applied) even if the load is a relatively small force. In this way, the decrease in the strength of the optical element is not preferable particularly in the mobile terminal such as a smartphone, because the function of protecting mechanically the imaging apparatus and the solid-state imaging element decreases.

In the antireflection film, generally, a dielectric material is formed by a vacuum deposition method such as vacuum vapor deposition, sputtering, or CVD. Break strength of the deposited dielectric material, when a stress is applied, is often lower than that of a transparent substrate such as a (bulk) glass substrate. Therefore, it is inferred that in the transparent substrate in which a dielectric material is deposited on one surface of an optical element, when the applied stress increases by bending, shock due to a falling ball, an indentation or the like, breaking of the deposited dielectric material occurs first, and breaking of the transparent substrate such as the glass substrate is induced from the breaking of the dielectric material as a starting point. It is inferred that, as a result, when the antireflection film is deposited on one surface of the optical element, the strength of the optical element becomes lower than that in the case where the antireflection film is not deposited on one surface of the optical element.

Based on the knowledge or the like obtained as above, the inventor of the present invention has arrived at the optical element having a structure in which a transparent resin film is present between one surface of the transparent substrate and the antireflection film, not the structure of depositing the antireflection film directly on the one surface of the transparent substrate.

(Optical Element)

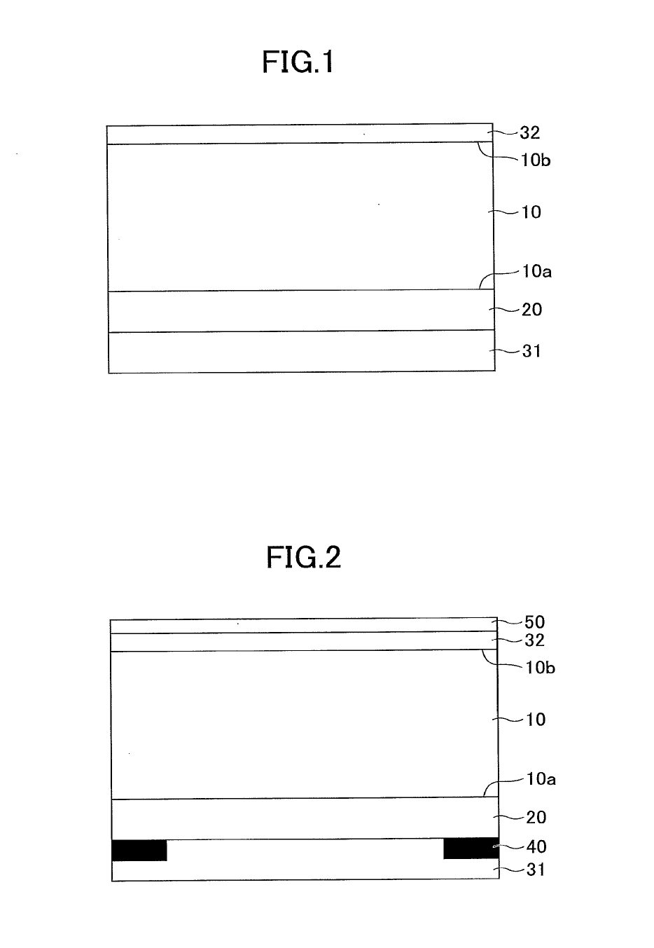

Next, the optical element according to the embodiment (in the following, referred to as a “present optical element”) will be described. The present optical element includes, as illustrated in FIG. 1, a resin layer 20 on a main surface 10a of a transparent substrate 10; and a first antireflection film 31 on the resin layer 20. Moreover, a second antireflection film 32 may be provided on another main surface 10b of the transparent substrate 10. A structure of the second antireflection film 32 is not particularly limited, and may be the same as a structure of the first antireflection film 31.

The present optical element is considered to absorb a stress applied to the first antireflection film 31 according to bending, shock due to a falling ball, an indentation or the like by the resin layer 20 between the main surface 10a of the transparent substrate 10 and the first antireflection film 31. In this way, by absorbing the stress applied to the first antireflection film 31, a state of the main surface 10a of the transparent substrate 10 moves closer to the state where the first antireflection film 31 is absent. Therefore, even when a force is applied from the other surface 10b of the transparent substrate 10, the strength of the same level as the case where the first antireflection film 31 is absent can be obtained. A resin material used for the resin layer 20 of the present optical element is not particularly limited, but requires glass-transition temperature (Tg) of 35° C. or more. When the temperature Tg is lower than 35° C., the resin material may melt in a heating process at the time of manufacturing. The temperature Tg of the resin material is preferably 50° C. or more, more preferably 70° C. or more, and further preferably 100° C. or more. Moreover, an upper limit for the temperature Tg of the resin material is not particularly defined. However, when the temperature Tg becomes higher, the resin material tends to be harder. Therefore, in order to obtain the effect of the stress absorption, the temperature Tg of the resin material is preferably 500° C. or less, and more preferably 300° C. or less.

Moreover, the optical element illustrated in FIG. 1 includes a resin layer 20 on the main surface 10a of the transparent substrate 10. However, the resin layer may also be provided on the other main surface 10b of the transparent substrate 10, i.e. between the transparent substrate 10 and the second antireflection film 32. In this case, the resin layer is required to be a resin material that transmits light, but is not particularly limited as long as a condition for the resin layer 20, which will be described below, is satisfied. In this way, in the case where the resin layers are provided on both surfaces of the transparent substrate, great strength can be obtained when a pressure is applied to the optical element from any of the main surfaces.

(Structure of Optical Element)

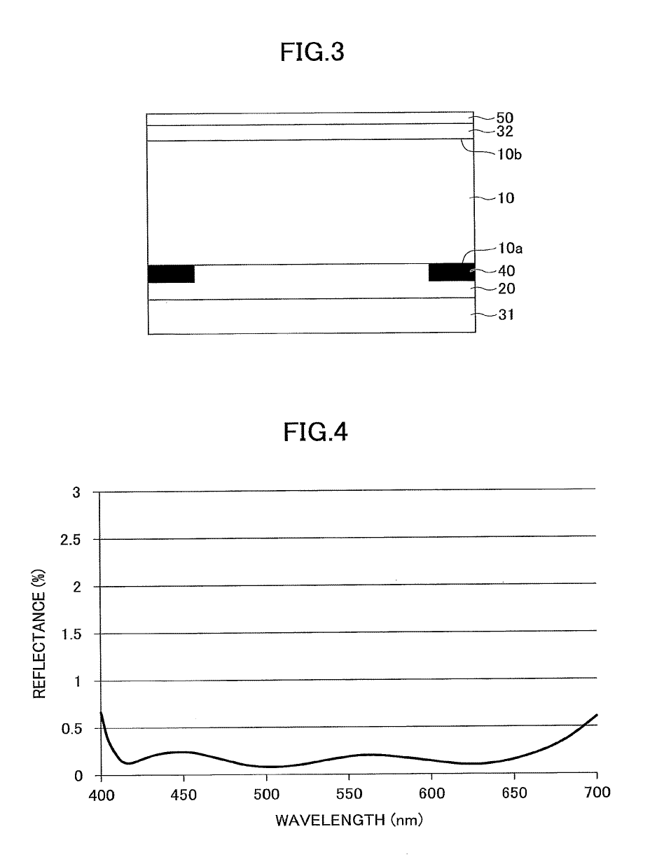

The basic configuration of the present optical element has been described in the above description. In the following, other examples of the configuration of the present optical element will be described with reference to FIGS. 2 and 3.

An optical element illustrated in FIG. 2 includes a resin layer 20 and a first antireflection film 31 on a main surface 10a of a transparent substrate 10 such as a glass substrate in this order. Moreover, the optical element further includes a light shielding film 40 between the resin layer 20 and the first antireflection film 31. The light shielding film 40 functions as a diaphragm, and is provided in a peripheral part of the resin layer 20 so as to open in the central part. Moreover, the optical element further includes a second antireflection film 32 and an antifouling film 50 on the other main surface 10b of the transparent substrate 10 in this order.

Moreover, an optical element illustrated in FIG. 3 includes a resin layer 20 and a first antireflection film 31 on a main surface 10a of a transparent substrate 10 such as a main a glass substrate. Moreover, the optical element includes a light shielding film 40 between the transparent substrate 10 and the resin layer 20. The light shielding layer 40 functions as a diaphragm in the same way as the configuration illustrated in FIG. 2, and is provided in a peripheral part of the resin layer 20 so as to open in the central part. Moreover, the optical element further includes a second antireflection film 32 and an antifouling film 50 on the other main surface 10b of the transparent substrate 10 in this order.

In the present optical element, a main surface 10a side of the transparent substrate 10 having the first antireflection film 31 will be denoted as “inside”, and another main surface 10b side of the transparent substrate 10 having the second antireflection film 32 and the antifouling film 50 will be denoted as “outside”. In this way, the optical element having the antifouling film 50 has an effect of reducing contaminations from outside, such as a fingerprint residue, when the antifouling film 50 is arranged, for example, at a position of covering the imaging apparatus so as to be in contact with external air.

The transparent substrate 10 is preferably a glass substrate with a thickness of 0.1 mm or more but 1 mm or less. The glass substrate is more preferably a chemically strengthened glass substrate. When the thickness of the transparent substrate 10 is less than 0.1 mm, a desired strength may not be obtained. Moreover, when the thickness of the transparent substrate 10 is greater than 1 mm, downsizing or slimming may be difficult upon using in a mobile terminal. The chemically strengthened glass refers to a glass in which strength against bending or a drop impact is improved by a chemical process.

Moreover, the light shielding film 40 is provided so as to obtain a diaphragm function, as described above. A material having a light-shielding property can be used. The arrangement of the light shielding film 40 is not particularly limited. The light shielding film 40 may be arranged on any of the main surface 10a and the other main surface 10b of the transparent substrate 10, or may be arranged on a surface of the antireflection film opposite to the transparent substrate. When the light-shielding film 40 is arranged on the main surface 10a of the transparent substrate 10 on which a solid-state imaging element is provided, for example, an effect of enhancing a light-shielding property against stray light reflected from the solid-state imaging element can be obtained.

In the present optical element, the solid-state imaging element is provided inside the first antireflection film 31. An object from outside is imaged by the solid-state imaging element via the optical element. Therefore, for example, the optical element is arranged at a position of covering the imaging apparatus, i.e. the position in contact with external air. When the optical element collides with an obstacle from outside, a force is applied to the optical element from the other main surface 10b side having the antifouling film 50. Therefore, when the optical element is arranged at the position of covering the imaging apparatus, as described above, the present optical element can exert the effect of reducing breakage by a direct collision with the obstacle. The present optical element is not necessarily arranged at the position in contact with external air, but may be arranged at a position which is located more inside the position of covering the imaging apparatus, i.e. a position not in contact with the external air, in response to a request for reducing breakage due to application of a pressure.

The dielectric multi-layer film in the first antireflection film 31 and the second antireflection film 32 can be formed by stacking alternately two or more materials having different refractive indices selected from inorganic materials including oxides, nitrides, fluorides, and the like of silicon, metals, or the like. For example, the antireflection film can be obtained by a dielectric multi-layer film which is formed by alternately stacking TiO₂ that is a high refractive index material and SiO₂ that is a low refractive index material, or a dielectric multi-layer film which is formed by alternately stacking Ta₂O₅ that is a high refractive index material and SiO₂ that is a low refractive index material.

The present optical element may include a filter layer that transmits visible light but reflects or absorbs infrared light or ultraviolet light, in addition to the first antireflection film 31 and the second antireflection film 32. Moreover, if each of the first antireflection film 31 and the second antireflection film 32 has a function as a filter layer in addition to the function as an antireflection film, the filter layer may not be provided in the optical element. For example, if the first antireflection film 31 and the second antireflection film 32 function as filters of preventing reflection of visible light and shielding a part or whole of infrared light or ultraviolet light, the filter layer for shielding a part or whole of infrared light or ultraviolet light may not be arranged in the optical element.

The antifouling film 50 is referred to as an Anti-fingerprint (AFP), and is formed of an antifouling coating agent illustrated, for example, by chemical formula 1. The antifouling film 50 is provided in order to prevent a fingerprint residue that is generated when the optical element is touched by hand, or in order to enable wiping off easily the fingerprint residue even if the fingerprint residue is present. The antifouling film 50 can be formed by vapor deposition or spin coating.

R_{f}—R¹—SiX₃₋ₓR²ₓ [Chemical formula 1]

The antifouling coating agent illustrated in chemical formula 1 includes fluorinated siloxane that is generated by applying a coating composition including fluorinated silane. In the chemical formula, R_{f} is an all fluorinated group including optionally one or more oxygen atoms; R¹ is a divalent alkylene group, arylene group, or a mixture of the alkylene group and arylene group including 2 to 16 carbon atoms, each of which is replaced by a hetero atom selected from one or more oxygen, nitrogen or sulfur, or replaced by a functional group selected from carbonyl, amide or sulfonamide; R² is a lower alkyl group; X is a halogen, a lower alkoxy group, or an acyloxy group, however, in the case where X-group includes an alkoxy group, at least one of acyloxy group or a halogen group exists; and x is zero or one.

The resin layer 20 includes an acrylic resin, an epoxy resin, a polyester resin, a silicone resin, a polycarbonate resin, a polyurethane resin, a polyuria resin, an ethylene-vinyl acetate copolymer resin, a polyvinyl alcohol resin modification material such as a polyvinyl butyral resin, a cycloolefin polymer resin, a polystyrene resin, a transparent fluorine resin, a transparent polyamide, a transparent polyimide, or the like.

The resin layer 20 can be prepared at low cost and with high productivity by preferably applying a liquid of the material forming the resin layer 20 in a spin coat system, an ink-jet system, a transfer system, or the like. Furthermore, the resin layer 20 may be formed by a screen printing.

Moreover, a refractive index of the resin layer 20 for light with a wavelength of 550 nm is required to be in a range of 1.2 to 1.8. When the transparent substrate 10 is a glass substrate, the refractive index of the resin layer 20 is preferably in a range of 1.4 to 1.65. Furthermore, in the resin layer 20, for light with a wavelength of 550 nm, smaller value of Δn, which is a difference in refractive index between the transparent substrate and the resin layer 20, is preferable, because reflection at an interface between the transparent substrate 10 and the resin layer 20 can be suppressed, and thereby a higher transmittance (low reflection performance) can be obtained. A range, which is not restricted by the thickness of the resin layer 20, is preferably 0≦Δn<0.2, more preferably 0≦Δn<0.15, and further preferably 0≦Δn<0.06. Moreover, from a viewpoint of cost, the resin layer 20 is preferably thinner. A range of the thickness t of the resin layer 20 is preferably t≦50 μm, more preferably t≦5 μm, and further preferably t≦0.5 μm. Moreover, because when the thickness t of the resin layer is too small, a predetermined strength may not be obtained, the range of the thickness t is required to be t≧10 nm, is preferably t≧20 nm, and more preferably t≧30 nm. According to the restriction from the material or the like, because when Δn≧0.2, a high transmittance can be obtained by controlling the thickness of the resin layer 20, a range of the product of Δn and t is preferably Δn×t≦300 nm, more preferably Δn×t≦150 nm, and further preferably Δn×t≦70 nm.

(Antireflection in Optical Element)

Next, an antireflection effect at the resin layer 20 and the first antireflection film 31 formed on the main surface 10a of the transparent substrate 10 will be described. FIG. 4 illustrates reflectance characteristics of light incident with an incident angle of 5° from a normal direction to an optical element surface (main surface of the optical element), obtained by simulation, in the case where the resin layer 20 and the first antireflection film 31 are foamed on the main surface 10a of the transparent substrate 10. The simulation was performed assuming that reflection from the other main surface 10b of the transparent substrate 10 is absent, i.e. back surface reflection is not present. FIG. 4 illustrates reflectance characteristics only of the main surface 10a of the transparent substrate 10. The simulation was performed for an optical element including a transparent substrate 10 which is a chemically strengthened glass with a refractive index of 1.52 and a thickness of 0.3 mm, the resin layer 20 including a transparent resin material with a refractive index of 1.53 and a film thickness of 500 nm, and a first antireflection film 31 on the resin layer 20. The first antireflection film 31 is formed by alternately stacking SiO₂ and TiO₂ (7 layers) on the resin layer 20.

As illustrated in FIG. 4, the reflectance from the main surface 10a side of the transparent substrate 10 is 0.3% or less in the wavelength range of 480 to 600 nm. Even when the resin layer 20 is provided between the transparent substrate 10 and the first antireflection film 31, the reflectance from the main surface 10a side can be suppressed to 2% or less. Therefore, in the present optical element, even when the resin layer 20 is provided, the antireflection effect by the first antireflection film 31 does not degrade. In addition, by providing a second antireflection film 32 with a reflectance of 2% or less on the other main surface 10b of the transparent substrate 10, the reflectance of the entire optical element can be suppressed to 4% or less, and the transmittance is enhanced. Moreover, the reflectance of the entire optical element, in the wavelength range of 480 to 600 nm, is required to be 2% or less, is more preferably 1% or less, and further preferably 0.5% or less. Moreover, extending the wavelength range, the reflectance of the entire optical element in the wavelength range of 450 to 650 nm is required to be 2% or less, is more preferably 1% or less, and further preferably 0.5% or less.

(Face Strength of Optical Element)

Next, face strength of the present optical element will be described based on Examples 1 to 8 and Comparative examples 1 to 3. TABLE 1 illustrates film configurations or the like of optical elements prepared in Examples 1 to 8. TABLE 2 illustrates film configurations or the like of optical elements prepared or the like in Comparative examples 1 to 3. In each of Examples 1 to 8 and Comparative examples 1 to 3, the optical element includes a chemically strengthened glass with a thickness of 0.3 mm and a diameter of 7.5 mm used for a transparent substrate. Moreover, the face strength is indicated by a force that breaks the optical element when a stainless ball with a diameter of 10 mm is pressed against the optical element from the other surface of the transparent substrate. The greater the value of the face strength is, the higher the strength of the optical element is.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| transparent | material | chemically strengthened glass | | | | | | | |
| substrate | thickness | 0.3 | | | | | | | |
| | (mm) | | | | | | | | |
| resin layer | material | polyester resin A | | | polyester resin B | | acrylic | acrylic resin B | |
| | | | | | | | resin A | | |
| | glass | 148° C. | | | 94° C. | | 230° C. | 78° C. | |
| | transition | | | | | | to 300° C. | | |
| | temperature | | | | | | | | |
| | thickness | 500 | 500 | 300 | 500 | 300 | 500 | 500 | 300 |
| | (nm) | | | | | | | | |

| first antireflection film | 7 layered film in which TiO₂ and SiO₂ are alternately stacked | | | | | | | |
|---|---|---|---|---|---|---|---|---|
| face strength (kgf) | 9.5 | 10.1 | 8.5 | 9.6 | 8.9 | 9.1 | 9.6 | 9.0 |

TABLE 2

| | | |
|---|---|---|
| comparative | comparative | comparative |
| example 1 | example 2 | example 3 |

| | | |
|---|---|---|
| transparent | material | chemically strengthened glass |
| substrate | thickness (mm) | 0.3 |

| first antireflection film | none | 6 layered film in which | |
|---|---|---|---|
| | | TiO₂ and SiO₂ are | |
| | | alternately stacked | |
| face strength (kgf) | 9.4 | 4.6 | 4.7 |

### EXAMPLE 1

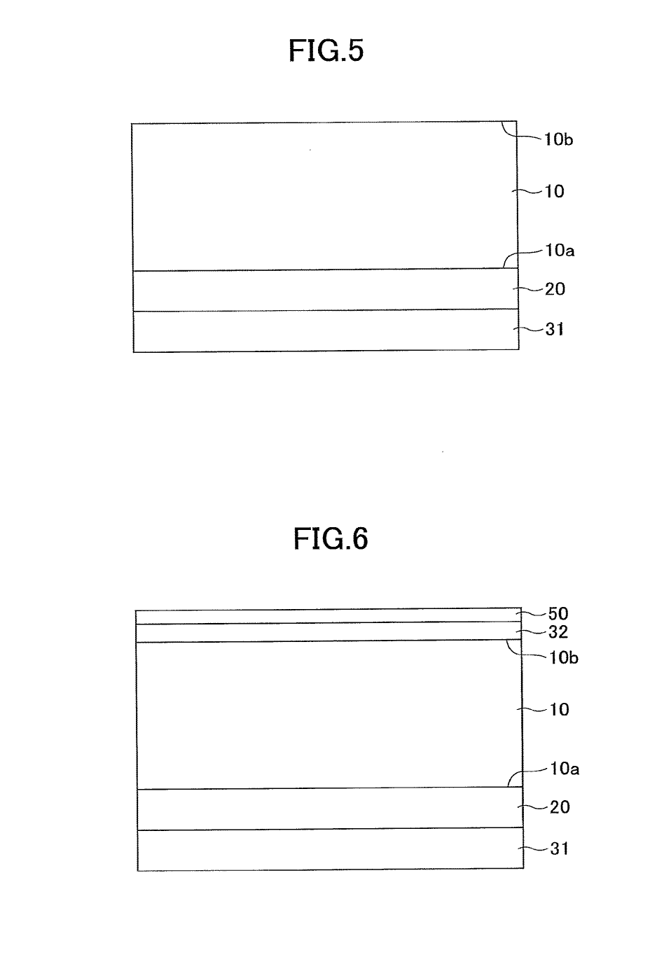

The optical element in Example 1 is an optical element having a structure illustrated in FIG. 5, in which a resin layer 20 and a first antireflection film 31 are stacked and formed on a main surface 10a of a chemically strengthened glass that is a transparent substrate 10 with a refractive index of 1.52, but nothing is formed on another main surface 10b. In Example 1, the resin layer 20 was formed by a polyester resin (polyester resin A: refractive index of 1.64) with a thickness of 500 nm on the main surface 10a of the transparent substrate 10. The first antireflection film 31 was formed by alternately stacking SiO₂ and TiO₂ (7 layers) on the resin layer 20. A difference in refractive index Δn between the transparent substrate 10 and the resin layer 20 in Example 1 was 0.12, and a product of Δn and the thickness t of the resin layer 20 was Δn×t=60 nm. Measured face strength of the optical element prepared in Example 1 was 9.5 kgf.

### EXAMPLE 2

The optical element in Example 2 has a structure illustrated in FIG. 6, in which a resin layer 20 and a first antireflection film 31 are stacked on a main surface 10a of a chemically strengthened glass that is a transparent substrate 10, and a second antireflection film 32 and an antifouling film 50 are stacked on another main surface 10b. In Example 2, the resin layer 20 was formed by a polyester resin (polyester resin A) with a thickness of 500 nm on the main surface 10a of the transparent substrate 10. The first antireflection film 31 was formed on the resin layer 20 in the same way as the optical element in Example 1. The second antireflection film 32 was formed by alternately stacking TiO₂ and SiO₂ (6 layers). The antifouling film 50 formed on the second antireflection film 32 was formed of a material including fluorine. A difference in refractive index Δn between the transparent substrate 10 and the resin layer 20 in Example 2 was 0.12, and a product of Δn and the thickness t of the resin layer 20 was Δn×t=60 nm. Measured face strength of the optical element prepared in Example 2 was 10.1 kgf.

### EXAMPLE 3

The optical element in Example 3 was prepared under the same condition as in Example 2, except that the thickness of the polyester resin (polyester resin A) that was the resin layer 20 was 300 nm. A difference in refractive index Δn between the transparent substrate 10 and the resin layer 20 in Example 3 was 0.12, and a product of Δn and the thickness t of the resin layer 20 was Δn×t=36 nm. Moreover, the second antireflection film 32 and the antifouling film 50 were formed in the same way as the optical element in Example 2. Measured face strength of the optical element prepared in Example 3 was 8.5 kgf.

### EXAMPLE 4

The optical element in Example 4 has a structure illustrated in FIG. 6, in which a resin layer 20 and a first antireflection film 31 are stacked on a main surface 10a of a chemically strengthened glass that is a transparent substrate 10, and a second antireflection film 32 and an antifouling film 50 are stacked on another main surface 10b. In Example 4, the resin layer 20 was formed by a polyester resin (polyester resin B different from the polyester resin A: refractive index of 1.53) with a thickness of 500 nm on the main surface 10a of the transparent substrate 10. The first antireflection film 31 was formed on the resin layer 20 in the same way as the optical element in Example 1. A difference in refractive index Δn between the transparent substrate 10 and the resin layer 20 in Example 4 was 0.01, and a product of Δn and the thickness t of the resin layer 20 was Δn×t=5 nm. Moreover, the second antireflection film 32 and the antifouling film 50 were formed in the same way as the optical element in Example 2. Measured face strength of the optical element prepared in Example 4 was 9.6 kgf.

### EXAMPLE 5

The optical element in Example 5 was prepared under the same condition as in Example 4, except that the thickness of the polyester resin (polyester resin B) that was the resin layer 20 was 300 nm. A difference in refractive index Δn between the transparent substrate 10 and the resin layer 20 in Example 5 was 0.01, and a product of Δn and the thickness t of the resin layer 20 was Δn×t=3 nm. Moreover, the second antireflection film 32 and the antifouling film 50 were formed in the same way as the optical element in Example 2. Measured face strength of the optical element prepared in Example 5 was 8.9 kgf.

### EXAMPLE 6

The optical element in Example 6 has a structure illustrated in FIG. 6, in which a resin layer 20 and a first antireflection film 31 are stacked on a main surface 10a of a chemically strengthened glass that is a transparent substrate 10, and a second antireflection film 32 and an antifouling film 50 are stacked on another main surface 10b. In Example 6, the resin layer 20 was formed by an acrylic resin (acrylic resin A: refractive index of 1.57) with a thickness of 500 nm on the main surface 10a of the transparent substrate 10. The first antireflection film 31 was formed on the resin layer 20 in the same way as the optical element in Example 1. A difference in refractive index Δn between the transparent substrate 10 and the resin layer 20 in Example 6 was 0.05, and a product of Δn and the thickness t of the resin layer 20 was Δn×t=25 nm. Moreover, the second antireflection film 32 and the antifouling film 50 were formed in the same way as the optical element in Example 2. Measured face strength of the optical element prepared in Example 6 was 9.1 kgf.

### EXAMPLE 7

The optical element in Example 7 has a structure illustrated in FIG. 6, in which a resin layer 20 and a first antireflection film 31 are stacked on a main surface 10a of a chemically strengthened glass that is a transparent substrate 10, and a second antireflection film 32 and an antifouling film 50 are stacked on another main surface 10b. In Example 7, the resin layer 20 was formed by an acrylic resin (acrylic resin B different from the acrylic resin A: refractive index of 1.50) with a thickness of 500 nm on the main surface 10a of the transparent substrate 10. The first antireflection film 31 was formed on the resin layer 20 in the same way as the optical element in Example 1. A difference in refractive index Δn between the transparent substrate 10 and the resin layer 20 in Example 7 was 0.02, and a product of Δn and the thickness t of the resin layer 20 was Δn×t=10 nm. Moreover, the second antireflection film 32 and the antifouling film 50 were formed in the same way as the optical element in Example 2. Measured face strength of the optical element prepared in Example 7 was 9.6 kgf.

### EXAMPLE 8

The optical element in Example 8 was prepared under the same condition as in Example 7, except that the thickness of the acrylic resin (acrylic resin B) that was the resin layer 20 was 300 nm. A difference in refractive index Δn between the transparent substrate 10 and the resin layer 20 in Example 8 was 0.02, and a product of Δn and the thickness t of the resin layer 20 was Δn×t=6 nm. Moreover, the second antireflection film 32 and the antifouling film 50 were formed in the same way as the optical element in Example 2. Measured face strength of the optical element prepared in Example 8 was 9.0 kgf.

### COMPARATIVE EXAMPLE 1

The optical element in Comparative example 1 is only a chemically strengthened glass that is a transparent substrate 10. Measured face strength was 9.4 kgf. However, in Comparative example 1, a first antireflection film 32 or a second antireflection film 32 is not formed, and a reflectance for visible light was about 8%. Therefore, high transmittance was not obtained.

### COMPARATIVE EXAMPLE 2

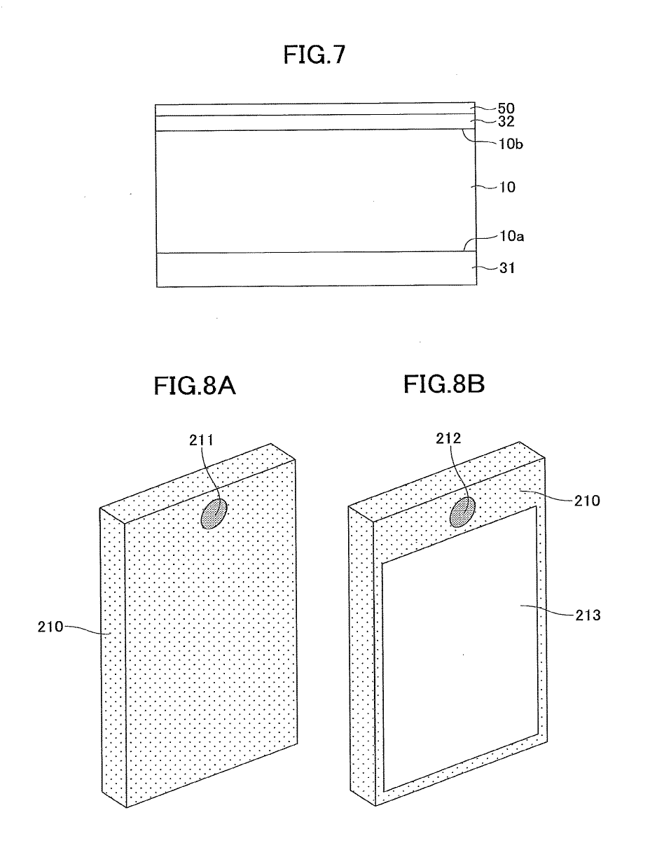

The optical element in Comparative example 2 has a structure illustrated in FIG. 7, in which a first antireflection film 31 is formed on a main surface 10a of a chemically strengthened glass that is a transparent substrate 10, and a second antireflection film 32 and an antifouling film 50 are stacked and formed on another main surface 10b. The first antireflection film 31 and the second antireflection film 32 in the Comparative example 2 were formed by alternately stacking TiO₂ and SiO₂ (6 layers) on the transparent substrate 10, respectively. The antifouling film 50 was formed of a material including fluorine on the second antireflection film 32. Measured face strength of the optical element prepared in Comparative example 2 was 4.6 kgf.

### COMPARATIVE EXAMPLE 3

The optical element in Comparative example 3 has a structure illustrated in FIG. 7, in which a first antireflection film 31 is formed on a main surface 10a of a chemically strengthened glass that is a transparent substrate 10, but nothing is formed on another main surface 10b. The first antireflection film 31 in the Comparative example 3 was formed by alternately stacking TiO₂ and SiO₂ (6 layers) on the main surface 10a of the transparent substrate 10. Measured face strength of the optical element prepared in Comparative example 3 was 4.7 kgf.

Among Comparative examples 1 to 3, the optical element, in which the first antireflection film 31 is formed directly on the main surface 10a of the transparent substrate 10, such as the optical elements in Comparative examples 2 and 3, has the low face strength, e.g. about a half of the face strength of the optical element in Example 1.

Moreover, as in the optical element in Example 1, comparable face strength to the case of Comparative example 1, in which the optical element is only a transparent substrate, can be obtained by forming the resin layer 20 on the main surface 10a of the transparent substrate 10 and forming the first antireflection film 31 on the resin layer 20. Furthermore, also in the case of forming the second antireflection film 32 on the other main surface 10b, as in the optical elements in Examples 2 to 8, decrease in the face strength was not observed, and the comparable face strength to the case of Comparative example 1, in which the optical element is only a transparent substrate, can be obtained.

As described above, in the present optical element, even when an antireflection film including dielectric multi-layer film is arranged on the main surface 10a of the transparent substrate 10, or on both surfaces of the transparent substrate 10, the face strength of the optical element does not decrease. Therefore, in the embodiment, degradation of strength can be suppressed, and an optical element having high light transmittance can be obtained.

### Second Embodiment

Next, a second embodiment will be described. In the second embodiment, an imaging apparatus using the present optical element (in the following, referred to as a “present imaging apparatus”) will be described. The present imaging apparatus is installed, for example, on electronic equipment provided with a communication function, such as a smartphone or a mobile phone.

Specifically, as illustrated in FIG. 8, the present imaging apparatus is installed on a smartphone 210 as a main camera 211 or a sub camera 212. The present imaging apparatus is installed, as the main camera 211, on a surface opposite to a surface where a display screen 213 is provided in the smartphone 210. Moreover, the present imaging apparatus is installed, as the sub camera 212, on the surface where the display screen 213 is provided. FIG. 8A is a perspective view of a rear side of the smartphone 210, and FIG. 8B is a perspective view of the display screen 213 side of the smartphone 210.

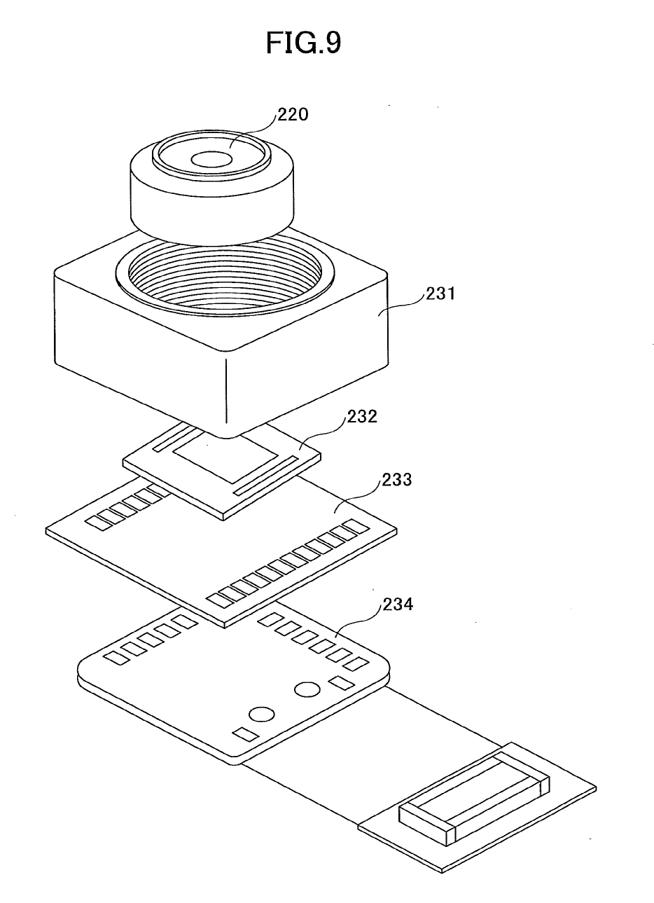

Each of the main camera 211 and the sub camera 212 of the present imaging apparatus includes, as illustrated in FIG. 9, an optical system 220, an automatic focusing unit 231, an image sensor 232 that is a solid-state imaging element, a substrate 233, a flexible substrate 234 or the like. The optical system 220 is installed on the automatic focusing unit 231, motion of the optical system 220 is controlled by the automatic focusing unit 231, and an autofocusing operation is performed. The image sensor 232 that is the solid-state imaging element is a CMOS sensor or the like. At the image sensor 232, an image by light incident via the optical system 220 is detected.

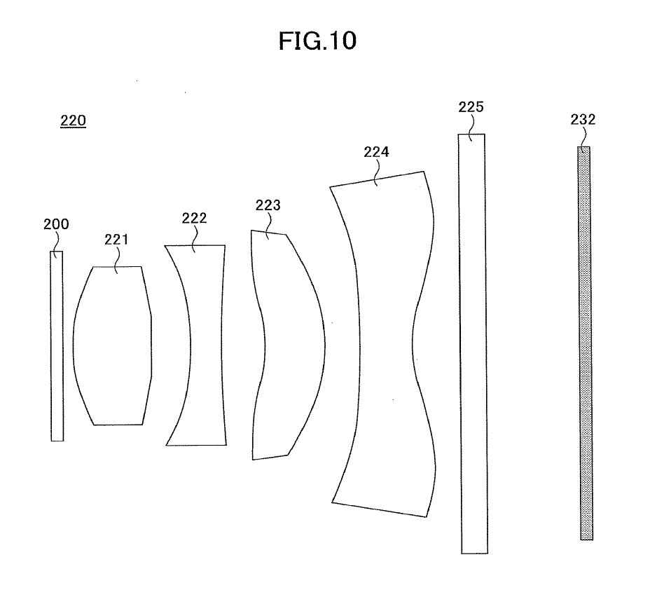

The optical system 220 includes, for example, as illustrated in FIG. 10, an optical element 200, a first lens 221, a second lens 222, a third lens 223, a fourth lens 224, and an infrared cut filter 225. The optical element 200 is arranged so that the main surface 10a of the transparent substrate 10, on which the first antireflection film 31 is formed, and the image sensor 232 that is the solid-state imaging element oppose each other.

In the optical system 220, light emitted from the optical element 200, enters the image sensor 232 through first lens 221, the second lens 222, the third lens 223, the fourth lens 224, and the infrared cut filter 225.

In the case of the optical element in the imaging apparatus installed in the mobile terminal, disclosed in Japanese Unexamined Patent Application Publication No. 2004-297398, Japanese Unexamined Patent Application Publication No. 2006-171569, or the like, in order to improve a light transmittance, an antireflection film is provided on a transparent substrate such as glass that transmits light.

Because the mobile terminal is portable, when an obstacle or the like contacts a surface of the imaging apparatus installed in the mobile terminal, the imaging apparatus may be broken. Therefore, in order to protect the solid-state imaging element in the imaging apparatus installed on the mobile terminal, for example, an outermost optical element (protecting member), i.e. an optical element located at a position in contact with external air is preferably especially hard. Moreover, not limited to the outermost position, an optical element used in the mobile terminal or the like is also preferably hard.

For an optical element having antireflection films on both sides of a transparent substrate, strength of the optical element may be reduced by having the antireflection films. In this way, when the strength of the optical element is reduced, the function as the optical element that is provided in order to protect the imaging apparatus installed in the mobile terminal and protecting the solid-state imaging element may be deteriorated. It is not preferable. Therefore, an optical element that suppresses degradation of strength, and has a high light transmittance is desired.

According to the present invention, an optical element that suppresses degradation of strength, and has a high light transmittance, is provided.

What is claimed is:

1. An optical element comprising:
a transparent substrate configured to transmit light;
a resin layer provided on one surface of the transparent substrate, and configured to transmit light; and
a first antireflection film formed on the resin layer.

2. The optical element according to claim 1,
wherein the transparent substrate is a glass substrate.

3. The optical element according to claim 1,
wherein a refractive index of the resin layer for light with a wavelength of 550 nm is greater than 1.2 but less than or equal to 1.8.

4. The optical element according to claim 1,
wherein a difference in refractive index Δn between the transparent substrate for light with a wavelength of 550 nm and the resin layer for light with a wavelength of 550 nm satisfies 0≦Δn<0.2.

5. The optical element according to claim 1,
wherein a difference in refractive index Δn between the transparent substrate for light with a wavelength of 550 nm and the resin layer for light with a wavelength of 550 nm satisfies 0.2 Δn, and
wherein a product of a thickness t of the resin layer and the difference in refractive index Δn satisfies Δn×t≦300 nm.

6. The optical element according to claim 1,
wherein a thickness of the resin layer is greater than or equal to 10 nm but less than or equal to 50 μm.

7. The optical element according to claim 1,
wherein when light, wavelength of which is in a range of greater than or equal to 480 nm but less than or equal to 600 nm, enters from a side having the first antireflection film, a reflectance at the first antireflection film is less than or equal to 2%.

8. The optical element according to claim 1,
wherein the transparent substrate includes a strengthened glass.

9. The optical element according to claim 1,
wherein a thickness of the transparent substrate is greater than or equal to 0.1 mm but less than or equal to 1 mm.

10. The optical element according to claim 1,
wherein the first antireflection film is a dielectric multi-layer film formed of an inorganic material.

11. The optical element according to claim 1,
wherein the resin layer includes a resin material with a glass-transition temperature of greater than or equal to 35° C.

12. The optical element according to claim 1,
wherein the resin layer includes any one of an acrylic resin, an epoxy resin, a polyester resin, and a silicone resin.

13. The optical element according to claim 1,
wherein the resin layer is provided on another surface of the transparent substrate.

14. The optical element according to claim 1,
wherein a second antireflection film is provided on another surface of the transparent substrate.

15. The optical element according to claim 14,
wherein an antifouling film formed of a material including fluorine is provided on the second antireflection film.

16. The optical element according to claim 1 further comprising:
a light-shielding film configured to shield a part of light that enters the transparent substrate.

17. An imaging apparatus comprising:
the optical element according to claim 1; and
a solid-state imaging element.

18. The imaging apparatus according to claim 17,
wherein a surface of the optical element on which the first antireflection film is formed and the solid-state imaging element are arranged so as to oppose to each other.

19. The imaging apparatus according to claim 17 further comprising:
a lens between the optical element and the solid-state imaging element.
